(19) United States
(12) Patent Application Publication
(10) Pub. No.: US 2015/0072046 A1
(43) Pub. Date: Mar. 12, 2015

(54) SEED BUTTER COMPOSITION AND FOOD PRODUCTS

(71) Applicant: William F. Aftoora, Brunswick, OH (US)

(72) Inventor: William F. Aftoora, Brunswick, OH (US)

(21) Appl. No.: 14/390,961

(22) PCT Filed: Apr. 6, 2013
(86) PCT No.: PCT/US2013/035533

§ 371 Date: Oct. 6, 2014

Related U.S. Application Data
(60) Provisional application No. 61/621,080, filed on Apr. 6, 2012.

(51) Int. Cl. A23L 1/36; A23L 1/0562; A23L 1/0524; A23L 1/0532; A23L 1/0526; A23L 1/30; A23L 1/302; A23L 1/303; A23L 1/08; A23L 1/076; A23L 1/0522

(52) U.S. Cl. CPC A23L 1/366; A23L 1/076; A23L 1/05625; A23L 1/0524; A23L 1/0532; A23L 1/05223; A23L 1/301; A23L 1/302; A23L 1/303; A23L 1/08; A23L 1/0526; A23V 2002/00
USPC 426/73; 426/629; 426/573; 426/576; 426/577; 426/575; 426/578; 426/532; 426/72

(57) ABSTRACT

An edible seed butter composition and consumable food products including the seed butter composition are disclosed. Method for preparing the edible seed butter composition and food products are also disclosed.

### CROSS REFERENCE TO RELATED APPLICATIONS

This application claims the benefit of the filing date under 35 U.S.C. §119(e) of U.S. Provisional Application For Patent Ser. No. 61/621,080, filed Apr. 6, 2012, which is hereby incorporated herein in its entirety.

### TECHNICAL FIELD

Disclosed is an edible seed butter that does not contain any peanuts or peanut-derived material, and consumable food products that incorporate the edible seed butter.

### BACKGROUND

Peanut butter is widely enjoyed by many people. The most common use of peanut butter is in preparing sandwiches, such as peanut butter and jelly sandwiches. Peanut butter's wide acceptance and popularity are attributed to its flavor, its nutritional value, and its suitability for consumption alone or in combination with a variety of other foods.

Many people have a hypersensitivity to peanuts, which causes hives, swelling, vomiting, diarrhea, rash and possibly anaphylactic shock. The serious nature of symptoms associated with hypersensitivity to peanuts prevents those allergic to peanuts from ingesting peanut butter.

### DETAILED DESCRIPTION

Provided is an edible seed butter composition comprising ground seeds other than peanuts and therefore the composition does not include peanuts or peanut-derived material. The seed butter composition may comprise a consistency similar to a traditional peanut butter, but without containing any peanuts or peanut-derived material. The seeds used to prepare the seed butter are selected from pumpkin seeds, sunflower seeds, sesame seeds, flax seeds, and the like, and mixtures thereof. The seeds are manipulated by breaking, grinding, crushing, mashing, mincing, milling, pounding, pulverizing, or like operations until the seeds enter into a fluid or semi-fluid state forming a paste or butter. The seeds may be raw seeds or treated seeds, such as roasted seeds and toasted seeds, and combinations of the raw and treated seeds. According to certain embodiments, the edible seed butter comprises a blend or mixture of ground seeds and seed oil. One or more different types of seeds are combined with at least one type of seed oil and other optional edible components or ingredients for prepare the composition. Without limitation, suitable seeds oils include vegetable oils. Suitable vegetable oils include, for example, sunflower oil, safflower oil, flaxseed oil, olive oil, grapeseed oil, and the like, and mixtures thereof.

According to other embodiments, provided is a food product comprising the seed butter composition comprising one or more than one type of non-peanut seeds, wherein the seed butter composition does not contain peanuts or peanut-derived material, and another food base or base material. According to other embodiments, provided is a food product comprising the seed butter composition comprising a blend or mixture of one or more type of non-peanut seeds and seed oil, wherein the seed butter composition does not contain peanuts or peanut-derived material, and another food base or base material.

According to certain illustrative embodiments, the seed butter composition comprises a mixture of at least one type of ground seeds and at least one type of seed oil. According to other illustrative embodiments, the seed butter composition comprises a mixture of more than one type of ground seeds and one of seed oil. According to other illustrative embodiments, the seed butter composition comprises a mixture of one type of ground seeds and more than one of seed oil. According to other illustrative embodiments, the seed butter composition comprises a mixture of more than one type of ground seeds and more than one type of seed oil.

According to certain illustrative embodiments, the seed butter composition comprises a ground blend or mixture of roasted pumpkin seed kernels, roasted sunflower seeds, toasted sesame seeds, honey, and at least one seed oil.

According to certain illustrative embodiments, and without limitation, the seed butter composition comprises a ground blend or mixture of roasted pumpkin seed kernels, roasted sunflower seeds, toasted sesame seeds, honey, grape seed oil, and sunflower seed oil.

According to certain illustrative embodiments, the seed butter composition comprises a ground blend or mixture of roasted pumpkin seed kernels, roaster sunflower seeds, ground flax seeds, toasted sesame seeds, honey, and at least one seed oil.

According to certain illustrative embodiments, the seed butter composition comprises a ground blend or mixture of roasted pumpkin seed kernels, roasted sunflower seeds, ground flax seeds, toasted sesame seeds, honey, grape seed oil, and sunflower seed oil.

The seed butter composition comprises a ground blend or mixture of roasted pumpkin seed kernels, roasted sunflower seed, toasted sesame seeds, honey, grape seed oil, flax seed oil, and sunflower seed oil.

According to certain embodiments, the seed butter composition comprises a ground blend or mixture of roasted pumpkin seed kernels, roasted sunflower seeds, ground flax seeds, tosated sesame seeds, honey, grape seed oil, flax seed oil, and sunflower seed oil.

According to any of the embodiment discloses herein, the ground sesame seeds may be provided in the form of Tahini Tahini is widely known in the food art as a ground roasted sesame seed paste.

The seed butter food product may contain an effective amount of a solidifying or gelling agent to effect solidification of the seed butter food product to form a semi-solid or solid seed butter product. Without limitation, solidifying agents that are useful in the seed butter food composition include gelatin, pectin, guar gum, xanthan gum, locust bean gum, gum arabic, cellulose gums, edible agar, tracaganth, carrageenan, alginate, modified food starch, mixtures thereof, and the like.

According to certain embodiments, the seed butter composition further comprises nutritionally effective amounts of at least one vitamin, or at least one mineral, or a combination of at least one vitamin and at least one mineral.

According to certain embodiments, the seed butter composition comprises a nutritionally effective amount of at least one vitamin. According to certain embodiments, the seed butter composition comprises a nutritionally effective amount of more than one different vitamin.

According to certain embodiments, the seed butter composition comprises a nutritionally effective amount of at least one mineral. According to certain embodiments, the seed butter composition comprises a nutritionally effective amount of more than one different mineral.

According to certain embodiments, the seed butter composition comprises a nutritionally effective amount of at least one vitamin and at least one mineral.

According to certain embodiments, the seed butter composition comprises a nutritionally effective amount of more than one different vitamin and at least one mineral. According to certain embodiments, the seed butter composition comprises a nutritionally effective amount of at least one vitamin and more than one different mineral. According to certain embodiments, the seed butter composition comprises a nutritionally effective amount of more than one different vitamin and more than one different mineral.

For example, and without limitation, the vitamins that maybe included in the seed butter composition may include Vitamin B Complex, Vitamin B-6, Vitamin B-12, Vitamin C, Vitamin D, Vitamin E (d-alpha tocopherol) and mixtures thereof.

The seed butter composition may also includes an effective amount of royal jelly, bee propolis, and bee pollen.

According to certain illustrative embodiments, the seed butter composition further comprises an antimicrobial preservative. Any known antimicrobial preservative typically used in the food arts and that is generally regarded as safe for human consumption may be included in the seed butter composition. Without limitation, according to certain embodiments, suitable antimicrobial preservatives include citric acid, potassium sorbate, sodium benzoate and mixtures thereof.

The seed butter composition comprises from about 20 to about 80 weight percent of at least one type of ground seed and greater than 0 to about 20 weight percent of at least one type of seed oil. According to other embodiments, the seed butter composition comprises from about 30 to about 70 weight percent of at least one type of ground seed and greater than 0 to about 30 weight percent of at least one type of seed oil. The seed butter composition comprises from about 40 to about 60 weight percent of at least one type of ground seed and greater than 0 to about 40 weight percent of at least one type of seed oil.

According to certain embodiments, the seed butter composition comprises from about 20 to about 50 parts by weight roasted pumpkin seed kernels, from about 20 to about 50 parts by weight roasted sunflower seeds, from about 20 to about 50 parts by weight toasted sesame seeds, from about greater than 0 to about 30 parts by weight raw honey, and from about greater than 0 to about 20 parts by weight of at least one seed oil.

According to certain embodiments, the seed butter composition comprises 36.5 parts by weight roasted pumpkin seed kernels, 23.75 parts by weight roasted sunflower seeds, 19.25 parts by weight toasted sesame seeds, 11.5 parts by weight raw honey, 3.5 parts by weight grape seed oil, and 0.5 parts by weight sea salt.

The seed butter may be provided in the form of a cuttable solid composition.

According to other illustrative embodiments, the seed butter may be provided in the form of a spreadable semi-solid or paste composition.

The seed butter compositions may optionally include salt, flavorings, inclusions, and nutritive enhancers. Nutritive enhancers may be selected from soluble fiber, insoluble fiber, fructo-oligosaccharides, insulins, psyllium husk fiber, citrus fiber, oat fiber, microground fiber, vegetable gums, dextrins, starches, grain brans, oat brans, wheat brans, corn brans, whey protein extracts, omega fatty acids, brown seaweeds, probiotics, prebiotics, ginko biloba, saw palmetto, milk thistle, bilberry, green tea, Echinacea, antioxidants, Golden Seal, ginseng, fruit concentrate, mangosteen, acai, astaxanthin, pomegranate, blue berry, cranberry, dates, figs, ginger, apricots, banana, chocolate, coconut, selenium, Co-Q 10, Pau d'arco, wheat grass, sterols, alfalfa, barley grass, beet fiber, oat fiber, apple pectin, black current fiber, flavones, isoflavones, soy, essential fatty acids, creatine, zinc, vitamins, and minerals.

The seed butter composition may include at least one artificial flavoring, at least one natural flavoring, or a combination of at least one artificial flavoring and at least one natural flavoring. Sucrose, fructose (e.g., D-fructose), glucose (e.g., D-glucose), and sweetener compositions comprising natural sugars, such as corn syrup (including high fructose corn syrup) or other syrups or sweetener concentrates derived from natural fruit and vegetable sources, semi-synthetic “sugar alcohol” sweeteners such as erythritol, isomalt, lactitol, mannitol, sorbitol, xylitol, maltodextrin, glycerol, threitol, arabitol, ribitol, dulcitol, and the like, and artificial sweeteners such as miraculin, aspartame, superaspartame, saccharin, saccharin-sodium salt, acesulfame-K, cyclamate, sodium cyclamate, and alitame. Sweeteners also include honey, maple syrup, vegetable glycerin, trehalose, melizitose, melibiose, raffinose, palatinose, lactulose, cyclamic acid, mogroside, tagatose (e.g., D-tagatose), maltose, galactose (e.g., D-galactose), L-rhamnose, D-sorbose, mannose (e.g., D-mannose), lactose, L-arabinose, D-ribose, D-glyceraldehyde, curculin, brazzein, Neohesperidin dihydrochalcone (NHDC), neotame and other aspartame derivatives, D-tryptophan, D-leucine, D-threonine, glycine, D-asparagine, D-phenylalanine, L-proline, maltitol, hydrogenated glucose syrup (HGS), magap, sucralose, lugduname, sucrononate, sucrooctate, monatin, trilobatin, Hesperetin Dihydrochalcone 4′-β-D-glucoside, phyllodulcin, hydrogenated starch hydrolyzate (HSH), stevioside, rebaudioside A and other sweet Stevia-based glycosides, thaumatin, monellin, carrelame and other guanidine-based sweeteners.

According to further illustrative embodiments, the seed butter may be incorporated into a wide variety of consumable food products. The seed butter comprising ground seeds, seed oil, and optional ingredients described herein may be combined with an edible food base or component to prepare a wide variety of consumable food products. For example, and not in limitation, the seed butter may be incorporated into bakery products such as breads, cookies, crackers, cakes, pastries, pies, pudding and the like. As a condiment, cooking ingredient (for example, soups, stews, chili, hummus, etc.), grilling, dipping and wing sauces, salad dressings and marinades, pasta and casserole sauces, candy, confectionary goods and granola/protein style bars, cereal and or snack food products, flavoring or ingredient for ice cream/custard, milk, milk shakes, health drinks, smoothies and the like, toppings for desserts or foods such as ice cream, french toast, pancakes etc. or any type foods or food groups that peanut butter is incorporated. Furthermore, the seed butter composition may be incorporated into pet foods, pet snacks, pet treats, and survival food.

The following examples are included to merely illustrate the various disclosed embodiments. These examples should not be construed as limiting the seed butter composition or methods of preparing the seed butter composition in any manner. All parts and ounces are “parts by weight” or “ounces by weight” unless otherwise noted.

### EXAMPLE 1

12 ounces of roasted pumpkin seed kernels, 10 ounces of roasted sunflower seeds, 8 ounces of toasted sesame seeds, 5 ounces of honey, 1.25 ounces of grape seed oil, 1 ounce of sunflower seed oil and 0.5 ounces of salt were combined and ground until a smooth consistency resembling a traditional peanut butter was achieved.

### EXAMPLE 2

12 ounces of roasted pumpkin seed kernels, 10 ounces of roasted sunflower seeds, 8 ounces of toasted sesame seeds, 5 ounces of honey, 2 ounces of flax seeds, 1.25 ounces of grape seed oil, 1 ounce of sunflower seed oil and 0.5 ounces of salt are combined and ground until a smooth consistency resembling a traditional peanut butter is achieved.

### EXAMPLE 3

12 ounces of roasted pumpkin seed kernels, 10 ounces of roasted sunflower seeds, 8 ounces of toasted sesame seeds, 5 ounces of honey, 1.25 ounces of grape seed oil, 1 ounce of sunflower seed oil, 1.25 ounces of flax seed oil, and 0.5 ounces of salt are combined and ground until a smooth consistency resembling a traditional peanut butter is achieved.

### EXAMPLE 4

12 ounces of roasted pumpkin seed kernels, 10 ounces of roasted sunflower seeds, 8 ounces of toasted sesame seeds, 2 ounces of flax seeds, 5 ounces of honey, 1.25 ounces of grape seed oil, 1 ounce of sunflower seed oil, 1.25 ounces of flax seed oil, and 0.5 ounces of salt are combined and ground until a smooth consistency resembling a traditional peanut butter is achieved.

### EXAMPLE 5

36.5 parts by weight unsalted roasted pumpkin seed kernels, 23.75 parts by weight unsalted roasted sunflower seeds roasted with sunflower seed oil, 19.25 parts by weight Tahini (ground toasted sesame seed paste), 11.5 parts by weight raw honey, 3.5 parts by weight grape seed oil, and 0.5 parts by weight sea salt are combined and ground until a smooth consistence resembling a traditional peanut butter is achieved.

### EXAMPLE 6

6 ounces by weight of roasted pumpkin seed kernels, 4.75 ounces of roasted sunflower seeds, 4 ounces of toasted sesame seeds, 2.5 ounces of honey, 1 ounce of vegetable glycerin, 0.75 ounces of grape seed oil, 0.75 ounces of vitamin E oil (d-alpha tocopherol), and 0.25 ounces of salt are combined and ground until a smooth consistency resembling a traditional peanut butter is achieved.

The seed butter and method of preparing the seed butter are not limited to the specific embodiments described above, but includes variations, modifications and equivalent embodiments defined by the following claims. The embodiments described above are not necessarily in the alternative, as various embodiments may be combined to provide the desired characteristics.

1. An edible seed butter composition comprising at least one type of ground seed, wherein said seed butter composition does not include peanuts or peanut-derived material.

2. The edible seed butter composition of claim 1, further comprising at least one seed oil.

3. The seed butter composition of claim 1, wherein said seeds are selected from the group consisting of pumpkin seeds, sunflower seeds, sesame seeds, flax seeds, soy seeds, and mixtures thereof.

4. The seed butter composition of claim 3, wherein said seed oil is selected from the group consisting of safflower oil, sunflower seed oil, grape seed oil, flax seed oil, olive oil, Vitamin E oil, and mixtures thereof.

5. The seed butter composition of claim 4, wherein said composition comprises ground seeds, seed oil, and honey.

6. The seed butter composition of claim 4, wherein said composition comprises ground roasted pumpkin seed kernels, ground roasted sunflower seeds, ground toasted sesame seeds, honey, and at least one seed oil.

7. The seed butter composition of claim 6, wherein said composition comprises ground roasted pumpkin seed kernels, ground roasted sunflower seeds, ground toasted sesame seeds, honey, grape seed oil, and sunflower seed oil.

8. The seed butter composition of claim 4, wherein said composition comprises ground roasted pumpkin seeds, ground roasted sunflower seeds, ground flax seeds, ground toasted sesame seeds, honey, and at least one seed oil.

9. The seed butter composition of claim 8, wherein said composition comprises ground roasted pumpkin seeds, ground roasted sunflower seeds, ground flax seeds, ground toasted sesame seeds, honey, grape seed oil, and sunflower seed oil.

10. The seed butter composition of claim 4, wherein said composition comprises ground roasted pumpkin seeds, ground roasted sunflower seeds, ground toasted sesame seeds, honey, grape seed oil, flax seed oil, and sunflower seed oil.

11. The seed butter composition of claim 4, wherein said composition comprises a blend or mixture of roasted pumpkin seed kernels, ground roasted sunflower seeds, ground flax seeds, ground toasted sesame seeds, honey, grape seed oil, flax seed oil, and sunflower seed oil.

12. The seed butter composition of claim 4, wherein said composition comprises from about 20 to about 50 parts by weight roasted pumpkin seeds, from about 20 to about 50 parts by weight roasted sunflower seeds, from about 20 to about 50 parts by weight toasted sesame seeds, from about greater than 0 to about 30 parts by weight raw honey, and from about greater than 0 to about 20 parts by weight of at least one seed oil.

13. The seed butter composition of claim 12, wherein said composition comprises 36.5 parts by weight roasted pumpkin seed kernals, 23.75 parts by weight roasted sunflower seeds, 19.25 parts by weight toasted sesame seeds, 11.5 parts by weight raw honey, 3.5 parts by weight grape seed oil, and 0.5 parts by weight sea salt.

14. The seed butter composition of claim 4, further comprising royal jelly, bee propolis, bee pollen, and mixtures thereof.

15. The seed butter composition of claim 4, further comprising an effective amount of a solidifying or gelling agent to effect solidification of the seed butter food product, wherein said solidifying or gelling agent is selected from the group consisting of gelatin, pectin, guar gum, xanthan gum, locust bean gum, gum arabic, cellulose gums, edible agar, tracaganth, carrageenan, alginate, modified food starch, and mixtures thereof.

16. The seed butter composition of claim 4, wherein said composition further comprises an antimicrobial preservative.

17. The seed butter composition of claim 4, wherein said composition further comprises at least one vitamin.

18. The seed butter composition of claim 17, wherein said vitamin is selected from the group consisting of Vitamin B Complex, Vitamin B-6, Vitamin B-12, Vitamin D, Vitamin E and mixtures thereof.

19. The seed butter composition of claim 17, wherein said composition further comprises at least one mineral.

20. The seed butter composition of claim 4, wherein said composition further comprises at least amino acid.

21. A consumable food product comprising:
(a) an edible seed butter composition comprising a blend of ground seeds and optionally seed oil, wherein said seed butter composition does not include peanuts or peanut-derived material and another food material; and
(b) a food base.
